(19) United States
(12) Patent Application Publication
(10) Pub. No.: US 2024/0339817 A1
(43) Pub. Date: Oct. 10, 2024

(54) Load Shedding For Portable Generator

(71) Applicant: J. D. North America Corp., Waukesha, WI (US)

(72) Inventors: Craig Serio, New Berlin, WI (US); David Flegel, Watertown, WI (US); Ken Stair, North Prairie, WI (US)

(21) Appl. No.: 18/628,057

(22) Filed: Apr. 5, 2024

Related U.S. Application Data
(60) Provisional application No. 63/457,874, filed on Apr. 7, 2023.

(51) Int. Cl. H02B 1/30; H01R 13/717

(52) U.S. Cl. CPC H02B 1/306; H01R 13/7175

(57) ABSTRACT

A portable power distribution system is provided that may include a portable generator and/or a power strip having a plurality of circuit outlets configured to provide power to a plurality of devices. The plurality of circuit outlets are configured to provide power to the devices in an order of priority. For instance, the system may include at least two outlets, with a first outlet taking priority over the second outlet, meaning that power to the second outlet is terminated if a maximum power output is exceeded, while power to the first outlet is maintained. Additional outlets may be provided that are also prioritized, such that the most important devices continue to have power supply, whereas power to less important devices is terminated if the maximum power outlet is exceeded.

### CROSS-REFERENCE(S) TO RELATED APPLICATION(S)

This application claims the benefit of priority on U.S. Provisional Patent Application Ser. No. 63/457,874, filed on Apr. 7, 2023 and entitled Load Shedding for Portable Generator, the entirety of which is hereby incorporated by reference.

### BACKGROUND OF THE INVENTION

### 1. Field of the Invention

The present invention relates in general to the field of portable generators. More particularly, the present invention relates to a portable generator that allows a user to prioritize the power load provided to multiple devices at once. Specifically, a preferred embodiment of the present invention relates to a portable generator that ceases power to components in a desired order. More specifically, the present invention is directed to a portable generator that sheds power from circuits having a lower priority in the event that the portable generator is reaching a point close to overload so as to avoid tripping a circuit breaker.

### 2. Discussion of the Related Art

Power supply systems have a variety of safety mechanism that allow the amount of power supplied to various components to be reduced or cut off when the system is close to, or surpasses an overload setting. For instance, buildings, as well as other devices, are equipped with circuit breakers that terminate supply of power when the load reaches a predetermined point. While providing an important safety feature, circuit breakers are inconvenient in that the power is completely terminated to the given circuit and associated region until a user resets the circuit breaker. This can lead to certain components connected to a given circuit to be without power for extended periods of time, which can cause significant issues. For instance, this can result in refrigerators or freezers being without power, which can lead perishable items to go bad. Additionally, power to furnaces and hot water heaters may be terminated, which similarly can result in significant issues for a home or building, including the freezing of pipes and uncomfortable living conditions. Similarly, air conditions and powered heaters can similarly be offline until the circuit breaker has been reset, which can result in undesirable conditions, particularly for young child, elderly, and animals.

Some permanent generators have improved upon the circuit breaker systems described above. For instance, some sophisticated permanent generators include a load shedding feature that allows a user to prioritize the various items hooked up to the permanent generator. For instance, a user can designate a desired order in which power supply is terminated if the load exceeds a safe level. By way of example, devices that are critical, such refrigerators, freezers, air conditioners, and powered heaters, can be plugged into higher priority outlets, whereas less important devices, such as personal electronics, lights, and other low-priority items can be plugged into lower priority outlets. When the permanent generator reaches a predetermined maximum overload of power supply, power to the lowest priority outlet can be terminated. If the permanent generator again reaches a maximum overload position, power supply to the next lowest priority outlet can be terminated. Thus, the permanent generator “sheds” the power requirements from the generator in the order in which the user prioritizes the use of all items plugged into the permanent generator.

While the load shedding components for permanent generators serve an important feature, they are not well suited for portable generators.

What is therefore needed is a load shedding portable generator that enables a user to move the generator from location to location while easily prioritizing the components powered by the generator. What is further needed are components uniquely suited to improve the load shedding functionality of a portable generator.

### SUMMARY AND OBJECTS OF THE INVENTION

By way of summary, the present invention is directed to a portable power distribution system that includes a portable generator, a plurality of circuit outlets associated with the portable generator in order to provide power to a plurality of devices, and a priority system associated therewith. The priority system is configured to allow a user to prioritize the plurality of circuit outlets used with the plurality of devices.

For instance, the plurality of circuit outlets may include a first circuit outlet and a second circuit outlet. The portable generator may have a maximum power output, and when that maximum power output is reached, power to the first circuit outlet may be maintained, whereas power to the second circuit outlet is terminated.

Similarly, the plurality of circuit outlets may include a first circuit outlet, a second circuit outlet, and a third circuit outlet. The portable generator may have a maximum power output, and when that maximum power output is initially reached, power to the first circuit outlet and second circuit outlet may be maintained, whereas power to the third circuit outlet is terminated. In the event that the maximum power output is reached a second time, power to the first circuit outlet may be maintained, whereas power to the second circuit outlet and the third circuit outlet is terminated.

According to another aspect of the present invention, the plurality of circuit outlets comprises a first plurality of circuit outlets and a second plurality of circuit outlets. Again, the portable generator has a designated maximum power output. When the designated maximum power output is reached, power to the first plurality of circuit outlets is maintained, whereas power to the second plurality of circuit outlets is terminated.

According to yet another aspect of the present invention, the plurality of circuit outlets may be physically oriented in order of importance. Additionally, a visual indicator may be provided that identifies the order of importance of the plurality of circuit outlets. Further still, the visual indicator may be one or more LED light indicators. For instance, the LED light indicators may be configured to display one or more of load percentage or usage. Further still, the portable power distribution system may further comprise at least one power strip.

According to another aspect of the present invention, a method of using a portable power distribution system is provided. The method may include the steps of supplying a portable generator having a plurality of circuit outlets, inserting power cords associated with a plurality of devices into the plurality of circuit outlets; and prioritizing the power supplied to each of the plurality of circuit outlets. Additionally, the method may include the steps of providing power to a first circuit outlet and a second circuit outlet, after which the total power supplied to the outlets is monitored. The total power is then compared to a maximum power output. Once the maximum power output is reached, power supply to the first circuit outlet is maintained, while power supply to the second circuit outlet is terminated. Further still, three circuit outlets may be provided, where power supply to the first circuit outlet and the second circuit outlet is maintained when the maximum power output is initially reached, whereas power supply to the third circuit outlet is terminated. If the maximum power output is again reached, power supply to the first circuit outlet is maintained, while power supply to the second and third circuit outlets is terminated.

Similarly, power may initially be supplied to a first plurality of circuit outlets and a second plurality of circuit outlets. In the event that the total power supplied reaches a maximum power output, power supply may be maintained to the first plurality of circuit outlets, whereas power supply to the second plurality of circuit outlets is terminated.

According to yet another aspect of the present invention, a portable power distribution system is provided that includes a portable power strip, a plurality of circuit outlets associated with the portable power strip, and a priority system. The portable power strip may further include at least a first outlet and a second outlet where power to the first outlet is maintained when a maximum power output is reached, and power to the second outlet is terminated when the maximum power output is reached.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRA WINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

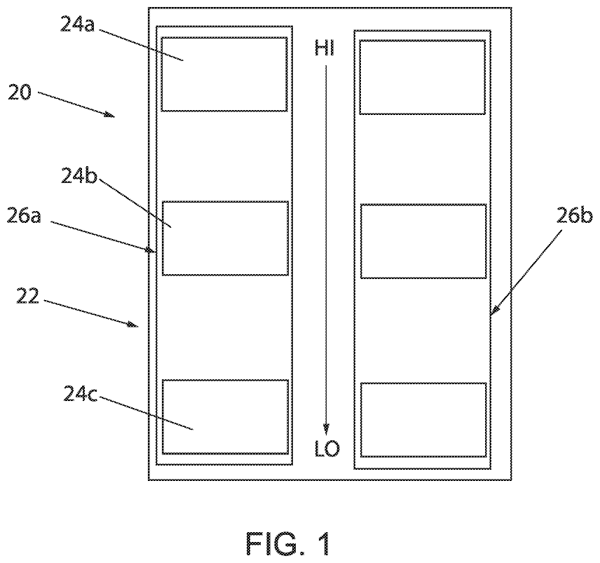

FIG. 1 illustrates a block diagram of the inventive load shedding system in use with a portable generator;

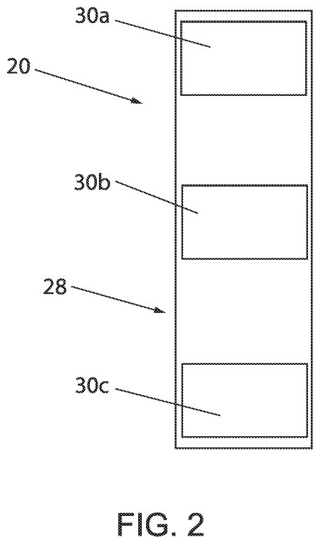

FIG. 2 illustrates a block diagram of the inventive load shedding system in use with a power strip;

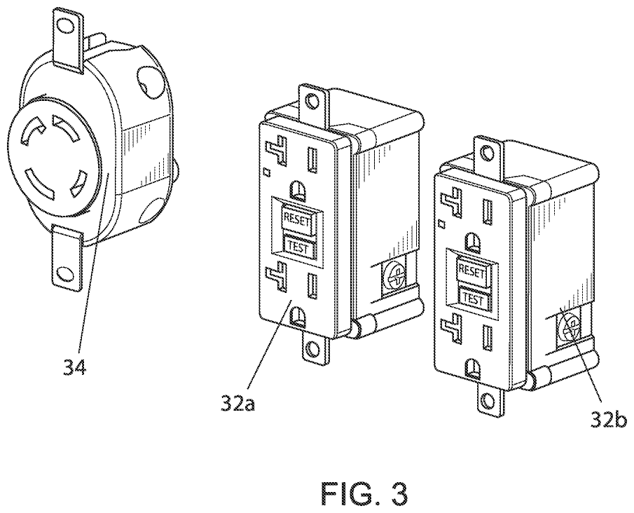

FIG. 3 illustrates various potential outlet types that may be used with the present inventive load shedding system;

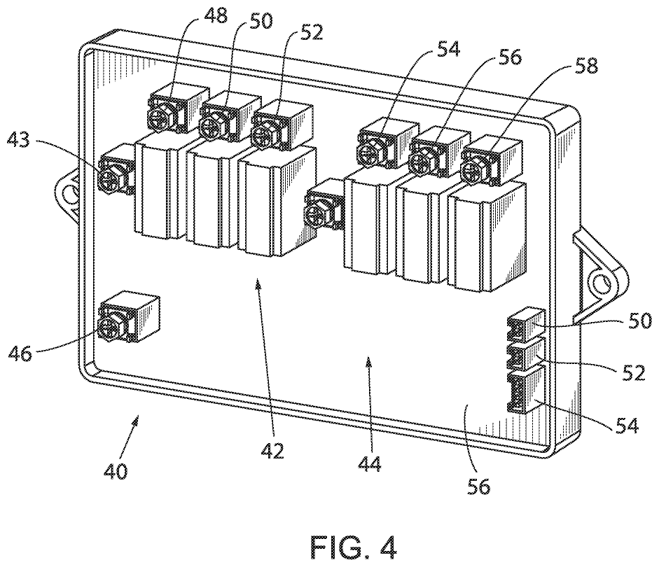

FIG. 4 illustrates a perspective view of the inventive load shedding system including two lines; and

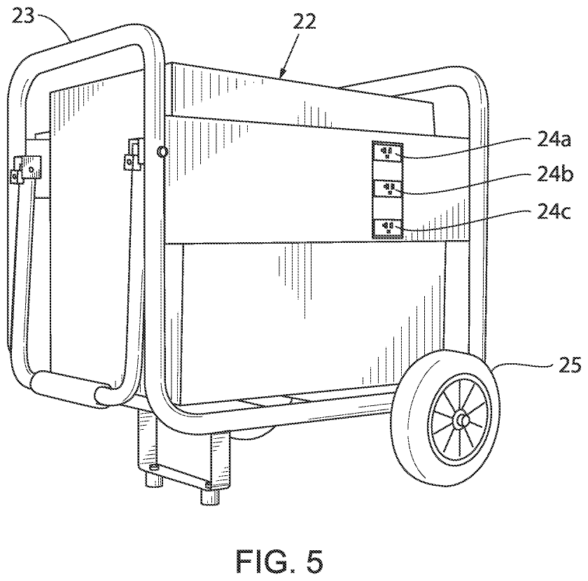

FIG. 5 illustrates a perspective view of a portable generator.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

### 1. System Overview

The present invention is directed to load shedding applied to portable generators that allow a user of the portable generator to assign circuit priorities. The ability to do so would direct the portable generator to “shed” the power from the circuit of less priority such that the portable generator would not overload. It also allows power supply to the circuit of higher priority to be maintained. This could allow the user to add more items than may traditionally be used with a single generator without tripping the circuit breaker on the generator and thus allowing power to continue during transient power demands. The control and circuits could be dedicated to an on board solution to the portable generator itself or could be incorporated into an extension cord or system connecting to the generator such that the user can see the load being used at the location of where they are plugging items into the cord. This allows continuous power to the circuits of the portable generator such that the load shedding technology automatically stops delivering power to the lower priority circuit instead of tripping the breaker and interrupting the total power delivery. Users can understand where to plug in higher priority items, like furnaces, hot water heaters, air conditions, refrigerators, freezers, and other critical items, such that those items are less likely to be without power. Additional features may include control modules, relays, current monitoring, and LED light indicators showing load percentage or usage.

### 2. Detailed Description of Preferred Embodiments

The present invention is directed to a portable power distribution system 20 configured to be moved from location to location to provide power to a variety of devices, including for instance, furnaces, hot water heaters, refrigerators, heaters, personal electronic devices, and the like. The system 20 advantageously allows for load shedding, that is, for power supply to certain outlets to be discontinued in a desired order in the event that a maximum power output is reached or surpassed before a surge is blown or the device otherwise fails. For instance, the circuits may be arranged in a specific order that allows a user to plug in the devices in a desired order, such that power to the more important devices is maintained.

In one embodiment, the system 20 includes a portable generator 22 as shown in FIG. 1. The portable generator 22 includes standard components, including a frame 23 and wheels 25 that enable the portable generator 22 to easily be moved from one location to another. The portable generator 22 has a plurality of circuit outlets 24. The outlets 24 are depicted as generic squares in the figures, but could include any number of different outlets, including single receptacle outlets, duplex receptacle outlets (see 32a, 32b in FIG. 3), twist and lock outlets (see 34 in FIG. 3), and any other different type of outlets as known to those having ordinary skill in the art. As shown, the portable generator 22 has three circuit outlets 24, although the generator 22 may have two outlets 24, or four or more outlets 24. Power is initially provided to all of the outlets 24. In the event that the total power provided to the outlets 24 exceeds a designated maximum power output, power to one or more of the lowest priority outlets 24 is discontinued. For instance, in the illustrated embodiment having three circuit outlets 24, power to the lowest priority outlet three 24c is discontinued when the maximum power output is exceeded, while power to the highest priority outlet one 24a and the medium priority outlet two 24b is maintained. In the event that the maximum power output is again exceeded, power to the medium priority outlet two 24b can also be discontinued, while power to the highest priority outlet one 24a is maintained. In this way, a user has the ability to prioritize power supply to various components, so that in the event that a maximum power output for a given portable generator 22 is exceeded, the entire portable generator 22 is not shut down, but instead less important components are depowered automatically without the need for the user to physically perform any tasks.

While the system 20 may include the portable generator 22 described above where the load shedding occurs on an outlet-by-outlet basis, the portable generator 22 could similarly shed loads in groups. For instance, the outlets 24 may be grouped into a first plurality of outlets 26a and a second plurality of outlets 26b. Of course, additional pluralities of outlets could also be included depending on the size of the portable generator 22 and the desires of a given user. This would enable a user to designate a group of outlets that are of higher or lower priority. For instance, all of the high priority devices may be plugged into the first plurality of outlets 26a, whereas all of the low priority devices may be plugged into the second plurality of outlets 26b. This would enable multiple devices to be depowered simultaneously once the designated maximum power output is met or surpassed, in which case the entire second plurality of outlets 26b would be depowered. Further still, the portable generator 22 may be toggled between modes where power is discontinued on an outlet-by-outlet basis, or power is discontinued for a plurality of outlets simultaneously. In yet other embodiments where duplex outlets are used such as in FIG. 3, power to both outlets may be discontinued simultaneously if a maximum power output is met or surpassed, otherwise power to one of the two duplex outlets may initially be discontinued, after which power to the other of the two duplex outlets may be discontinued if the maximum power output is met or surpassed a second time.

In addition to, or in the alternative of a portable generator 22, the system may also include a power strip 28 as shown in FIG. 2. The power strip 28 may be plugged into a portable generator or other power source. The power strip 28 includes multiple circuit outlets 30 like those described above for the portable generator 22. Again, the circuit outlets 30 allow a user to prioritize which outlets 30 (and in turn the devices plugged into those outlets 30) such that power is maintained for the highest or higher priority devices while power is discontinued to lower priority outlets 30 for lower priority devices if a threshold power supply level is exceeded. This may occur in the same way outlined above for the portable generator 22.

Further still, the system 20 may be equipped with various visual indicators to assists with use of the system 20. For instance, the system 20 may include text, color coding, a number system, arrows, and the like that help a user understand the order in which the outlets 24, 30 are prioritized. This would help to make it easy for a first-time user to understand the order in which devices should be plugged in to ensure high-priority devices are supplied with power over lower priority devices. For instance, looking to FIG. 1, the word “HI” is located at one end of the system 20 indicating the highest-priority outlet 24a, and the word “LO” is located at the opposite end of the system 20 indicating the lowest-priority outlet 24c, with an arrow extending therebetween to help a user understand the order of priority.

The outlets 24, 30 may be arranged in a straight line, with one end being the highest-priority outlets 24, 30, with the other end being the lowest-priority outlets 24, 30. Where the outlets 24, 30 are shed in groups, a first grouping of outlets 24, 30 may be located on one side of the system 20 along with other text, images, or visual indicators to designate high priority outlets, and a second grouping of outlets 24, 30 on the second side of the system 20 along with other text, images, or visual indicators to designate low priority outlets. Further still, the visual indicators may not be static, but rather can change. For instance, LED lights may be used that show which of the outlets 24, 30 are being supplied with power, and which of the outlets are no longer powered. In addition to visual indicators, the system 20 may also be equipped with audio indicators to notify a user that power has been discontinued to one or more of the circuits 24, 30. The system 20 may also communicate information wirelessly, for instance to a Smartphone or computer application, to a website, or to other devices that would enable a user to quickly and easily understand when power has been discontinued to one or more circuits 24, 30.

Turning briefly to FIG. 4, another embodiment of the present invention is included. More specifically, FIG. 4 illustrates a system 40 that includes a first line 42 connected to the generator at a first connection 43 and a second line 44 connected to the generator at a second connection 45, both of which are connected to the generator. The system 40 also includes a neutral connection 46 to the generator. The first line 42 is provided with 120 volts, which are connected to multiple priority outlets. Similarly, the second line 44 is provided with 120 volts, which are also connected to multiple priority outlets. More specifically, the first line 42 includes a first priority outlet 48, a third priority outlet 50, and a fifth priority outlet 52. The second line 44 includes a second priority outlet 54, a fourth priority outlet 56, and a sixth priority outlet 58. In the event that there is insufficient supply to power all six outlets, the power to the outlets will be depowered in reverse numerical order. Stated differently, power supply to the sixth priority outlet 58 will be discontinued first, followed by power to the fifth priority outlet 52. In this way, power to the first and second lines 42, 44 will alternatively discontinued if the total power threshold is surpassed.

Additionally, the system 40 may include other features, such as a start button 50, a reset button 52, an LED outlet on indicator 54, and a programming module 56, as shown one associated with Bluetooth. The start button 50 enables to system 40 to be powered on, and the reset button 52 allows the system 40 to be reset. As described above, the LED outlet on indicator 54 provides a user with visual indication of which outlets are currently powered on, for example using green LED lights for outlets that are powered “on” and red LED lights for outlets powered “off”. Additionally, the programming module 56 allows a user to control operation of the system 40. This can be done remotely, for instance, using Bluetooth.

The present invention is also directed to a method of using the system and components described above. The method can includes the steps of supplying a portable generator having a plurality of circuit outlets, inserting power cords associated with a plurality of devices into the plurality of circuit outlets, and prioritizing the power supplied to each of the plurality of circuit outlets. The method may also include providing power to a first circuit outlet and a second circuit outlet, monitoring the total power supplied to the first circuit outlet and the second circuit outlet, comparing the total power to a maximum power output, maintaining power supply to the first circuit outlet when the maximum power output is reached, and terminating power supply to the second circuit outlet when the maximum power output is reached. The method may further include providing power to a first circuit outlet, a second circuit outlet, and a third circuit outlet, monitoring the total power supplied to the first circuit outlet, the second circuit outlet, and the third circuit outlet, comparing the total power to a maximum power output, maintaining power supply to the first circuit outlet and the second circuit outlet when the maximum power output is initially reached, and terminating power supply to the third circuit outlet when the maximum power output is initially reached. Further still, the method may also include maintaining power supply to the first circuit outlet when the maximum power output is reached for a second time and terminating power supply to the second circuit outlet and the third circuit outlet when the maximum power output is reached for the second time. Additionally, the method may include providing power to a first plurality of circuit outlets and a second plurality of circuit outlets, monitoring the total power supplied to the first plurality of circuit outlets and the second plurality of circuit outlets, comparing the total power to a maximum power output, maintaining power supply to the first plurality of circuit outlets when the maximum power output is reached, and terminating power supply to the second plurality of circuit outlets when the maximum power output is reached. The method also may include inserting the power cords in an order of importance. Additionally, the method may include activating a visual indicator to identify the order of importance of the plurality of circuit outlets. Further, the method may include activating one or more LED light indicators to display one or more of load percentage or usage. Additionally, the method may also include providing at least one power strip.

All the disclosed embodiments are useful in conjunction with providing portable power supply to multiple devices having differing levels of importance and priority. There are virtually innumerable uses for the present invention, all of which need not be detailed here. All the disclosed embodiments can be practiced without undue experimentation.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

In addition, the individual components need not be fabricated from the disclosed materials, but could be fabricated from virtually any suitable materials. Moreover, the individual components need not be formed in the disclosed shapes, or assembled in the disclosed configuration, but could be provided in virtually any shape, and assembled in virtually any configuration. Further, although the various components are described herein as being physically separate modules, it will be manifest that any of the components may be manufactured together or later assembled with one another. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. A portable power distribution system comprising:
a portable generator comprising:
a frame;
a plurality of wheels connected to the frame that enable the portable generator to be propelled from a first location to a second location;
a plurality of circuit outlets associated with the portable generator to provide power to a plurality of devices; and
a priority system associated with the plurality of circuit outlets configured to allow a user to prioritize the plurality of circuit outlets used with the plurality of devices.

2. The portable power distribution system of claim 1, wherein the plurality of circuit outlets comprises a first circuit outlet and a second circuit outlet;
wherein the portable generator has a designated maximum power output;
wherein power to the first outlet is maintained when the designated maximum power output is reached; and
wherein power to the second outlet is terminated when the designated maximum power output is reached.

3. The portable power distribution system of claim 1, wherein the plurality of circuit outlets comprises a first circuit outlet, a second circuit outlet, and a third circuit outlet;
wherein the portable generator has a designated maximum power output;
wherein power to the first outlet and second outlet is maintained when the designated maximum power output is initially reached; and
wherein power to the third outlet is terminated when the maximum power output is initially reached.

4. The portable power distribution system of claim 3, wherein power to the first outlet is maintained when the designated maximum power output is reached for a second time; and
wherein power to the second outlet is terminated when the maximum power output is reached for a second time.

5. The portable power distribution system of claim 1, wherein the plurality of circuit outlets comprises a first plurality of circuit outlets and a second plurality of circuit outlets;
wherein the portable generator has a designated maximum power output;
wherein power to the first plurality of circuit outlets is maintained when the designated maximum power output is reached; and
wherein power to the second plurality of outlets is terminated when the designated maximum power output is reached.

6. The portable power distribution system of claim 1, further comprising a visual indicator identifying the order of importance of the plurality of circuit outlets.

7. The portable power distribution system of claim 6, wherein the visual indicator is one or more LED light indicators.

8. The portable power distribution system of claim 7, wherein the one or more LED light indicators are configured to display one or more of load percentage or usage.

9. A method of using a portable power distribution system, comprising the steps of:
supplying a portable generator having a plurality of circuit outlets;
inserting power cords associated with a plurality of devices into the plurality of circuit outlets; and
prioritizing the power supplied to each of the plurality of circuit outlets.

10. The method of claim 9, further comprising the steps of:
providing power to a first circuit outlet and a second circuit outlet;
monitoring the total power supplied to the first circuit outlet and the second circuit outlet;
comparing the total power to a maximum power output;
maintaining power supply to the first circuit outlet when the maximum power output is reached; and
terminating power supply to the second circuit outlet when the maximum power output is reached.

11. The method of claim 9, further comprising the steps of:
providing power to a first plurality of circuit outlets and a second plurality of circuit outlets;
monitoring the total power supplied to the first plurality of circuit outlets and the second plurality of circuit outlets;
comparing the total power to a maximum power output;
maintaining power supply to the first plurality of circuit outlets when the maximum power output is reached; and
terminating power supply to the second plurality of circuit outlets when the maximum power output is reached.

12. The method of claim 9, further comprising the step of activating a visual indicator to identify the order of importance of the plurality of circuit outlets.

13. The method of claim 12, wherein the visual indicator is one or more LED light indicators.

14. The method of claim 9, further comprising the step of providing at least one power strip.

15. A portable power distribution system comprising:
a portable power strip;
a plurality of circuit outlets associated with the portable power strip to provide power to a plurality of devices; and
a priority system associated with the plurality of circuits configured to allow a user to prioritize the plurality of circuit outlets used with the plurality of devices.

16. The portable power distribution system of claim 15, wherein the portable power strip comprises:
a first outlet; and
a second outlet;
wherein power to the first outlet is maintained when the portable power strip reaches a maximum power output; and
wherein power to the second outlet is terminated when the portable power strip reaches the maximum power output.

17. The portable power distribution system of claim 15, wherein the plurality of circuit outlets further comprises a first plurality of circuit outlets and a second plurality of circuit outlets;
wherein the first plurality of circuit outlets comprises a first duplex outlet having a first outlet and a second outlet;
wherein the second plurality of circuit outlets comprises second duplex outlet having a third outlet and a fourth outlet; and
wherein power to the second duplex outlet is discontinued when the designated maximum power output is initially reached and power to the first duplex outlet is maintained when the designated maximum power output is initially reached.

18. The portable power distribution system of claim 17, wherein power to the second outlet is discontinued when the designated maximum power output is subsequently reached and power to the first outlet is maintained when the designated maximum power output is subsequently reached.

19. The portable power distribution system of claim 17, wherein power to the fourth outlet is discontinued when the designated maximum power output is initially reached and power to the first outlet, the second outlet, and the third outlet is maintained when the designated maximum power output is initially reached.

20. The power distribution system of claim 19, wherein power to the third outlet is discontinued when the designated maximum power output is subsequently reached and power to the first outlet and second outlet is maintained; and
wherein power to the second outlet is discontinued when the designated maximum power output is reached for a third time and power to the first outlet is maintained.
